(19) United States
(12) Patent Application Publication
(10) Pub. No.: US 2012/0256431 A1
(43) Pub. Date: Oct. 11, 2012

(54) Golf ball retrieving device and methods of manufacturing and using same

(76) Inventor: Albert Moriarty, Waltham, MA (US)

(21) Appl. No.: 13/066,222

(22) Filed: Apr. 8, 2011

(51) Int. Cl. A63B 47/02; B29C 39/02

(52) U.S. Cl. 294/19.2; 264/299

(57) ABSTRACT

A golf ball retrieving device is described, having a specially shaped handle combined with a capturing member. The design and use are described, along with a preferred method of manufacturing the device.

### STATEMENT REGARDING FEDERALLY SPONSORED RESEARCH OR DEVELOPMENT:

Not Applicable.

### FIELD OF THE INVENTION

This invention relates to the field of golf equipment and, more specifically, to golf ball retrievers.

### BACKGROUND OF THE INVENTION

In the game of golf, various obstacles are present on the course to make play more challenging to the golfer. Such obstacles include water hazards as well as overgrown vegetation and sand traps. Among the most difficult hazards to deal with are the water hazards, where, even if the ball can be seen, it can not conveniently be reached to be retrieved.

The golfer is then confronted with either losing the golf ball or employing an implement to retrieve the ball from the obstacle. One such implement is disclosed in U.S. Pat. No. 5,437,487 to Fulop which employs a retaining device having a spring that is displaced upon entry of the golf ball into the retaining device. Once the ball completely passes through the entrance plane, the spring returns to its original position thus capturing the ball in the retaining device.

In U.S. Pat. No. 4,046,413 to Jeninga, a swinging gate is required to block the exit of the golf ball through an inverting motion of the device. Both the shape of the components and the associated movement of the device are integral to the operation of the invention.

Another such device is disclosed in U.S. Pat. No. 4,730,859 to Gabinet which employs a box-like structure having a rod across the front that is placed so as to move the golf ball upward upon contact and pass under the ball as it enters the device. Once the ball passes through the entrance plane, the rod serves to hold the ball in the device as it is pulled toward the golfer like a long-handled rake.

In the Gabinet patent, the box-like structure is pulled toward the golfer like a rake, by pulling the handle along its length. The device is pulled across the bottom and up the sides of the water hazard. A similar rake-like configuration is found in U.S. Pat. No. 4,635,987 and Schropp Des. 333,857. This type of configuration can produce an awkward position for the user at the end of the motion, as the device approaches the sides of the water hazard and the golfer must pull it directly up. The process of picking up a golf ball with a rake-like device presents a much more difficult process than simply raking it toward you or capturing it into some container.

These and many other devices employ complex mechanisms and multiply connected and moving parts to deal with the dynamics golf ball capture under water. Other devices try to simplify their construction by employing specially shaped components to deal with the golf ball dynamics, with specially formed shapes and ridges to prevent escape of the ball during and after capture. Complex devices require multiple parts that increase production cost and risk of failure. Complex shapes are more difficult and expensive to mold, and specially deformable materials are more expensive than rigid materials that do not require distortion or relative motion of their parts.

U.S. Pat. No. 7,178,844 to Evilsizer employs a double-cup-like structure capable of passing the golf ball through an opening after positioning it on top of the ball, and pressing the device down over the ball after the device is in the proper position with respect to the ball. This mechanism requires that the device be made of a flexibly deformable material, or in one embodiment, at least one of the walls of the device must be moveable in order to be displaced. This approach also requires specially moving parts, or the use of specially deformable materials.

In addition, the downward force required to capture the ball presents another problem by requiring the force to be exerted in a direction that can press the ball down into the mud, sand, or other soft surface that may form the floor of the water hazard or other obstacle.

It is therefore an object of this invention to provide a ball retriever simple and economical to construct and use, and reliable in its operation.

### BRIEF SUMMARY OF THE INVENTION

The current invention accomplishes the capture of a golf ball with a simple mechanism made possible by the design of the capturing member, combined with the design of the handle and method of attachment and use of the handle when it is employed with the capturing member in performing its function.

In the prior art, there are two common configurations and methods of use of the handle in conjunction with a capturing device.

In the Gabinet patent, when the box-like structure is pulled toward the golfer like a rake, the device is forced move across the bottom and up the sides of the water hazard, which may be dirty, rocky, and un-even. This can cause the ball to be lost when the user cannot sustain this motion.

In the Evilsizer Patent, the cup-like structure must be positioned on top of the ball, in a motion requiring highly accurate placement on a golf ball that may not be fully visible. The spring-driven capturing device of Fulop also requires an accurate placement at the end of a long handle.

In the current invention, a capturing member is affixed to the end of a handle so that it can be employed in a natural scooping motion either by rotating the handle or by swinging the handle so that the weight of the ball and the draining of the water through the drain openings in the bottom serves to swing the capture device to an upright position with the ball at its bottom. The design of the device and the size and shape of the opening makes it especially easy to sweep the handle through an arc so that it sweeps through a region that includes the golf ball for capture.

### BRIEF DESCRIPTION OF THE SEVERAL VIEWS OF THE DRAWINGS

FIG. 1 shows several views of the retrieving device, which incorporates a capturing device and a handle. The handle would be further attached to an extensible pole, (not shown or claimed) in a manner well known to those in the art.

FIG. 2 shows a cross-sectional view of one embodiment of the device, which shows the attachment of the handle and its relationship to the geometry of the device.

FIG. 3 shows a cross-sectional view of another embodiment of the device, with additional drain holes in the side. It also shows a flared lip and a diagram of the forces on a golf ball entering the device.

FIG. 4 shows a cross-sectional view of another embodiment of the device, with additional drain slots in the side.

### DETAILED DESCRIPTION OF THE PATENT

The drawings depict a golf ball retrieving device 10 designed to be placed at the end of a telescoping pole in a manner commonly known in the art.

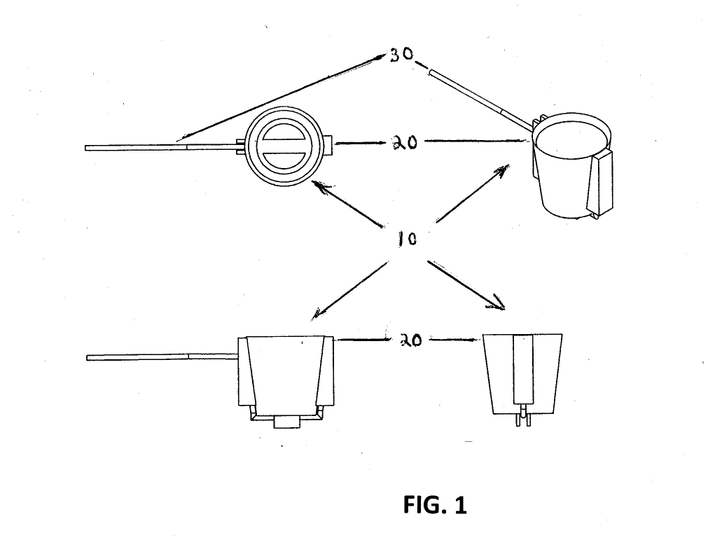

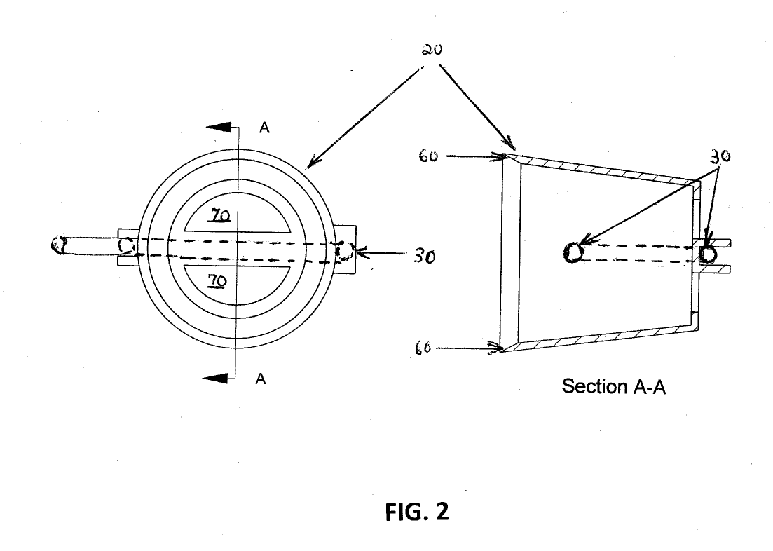

The retrieving device 10 of FIG. 1 has a generally cylindrical capturing member 20 attached to a handle 30 that is generally perpendicular to the axis of the cylinder, as shown in FIG. 2. This design feature permits the tipping of the capturing member by rotating the handle around its longest portion. When the plane of the handle is rotated to a horizontal position, the open end of the cylinder can be used to scoop up golf balls. The capturing member has a tapered edge which aids in the capture by a method which will be described.

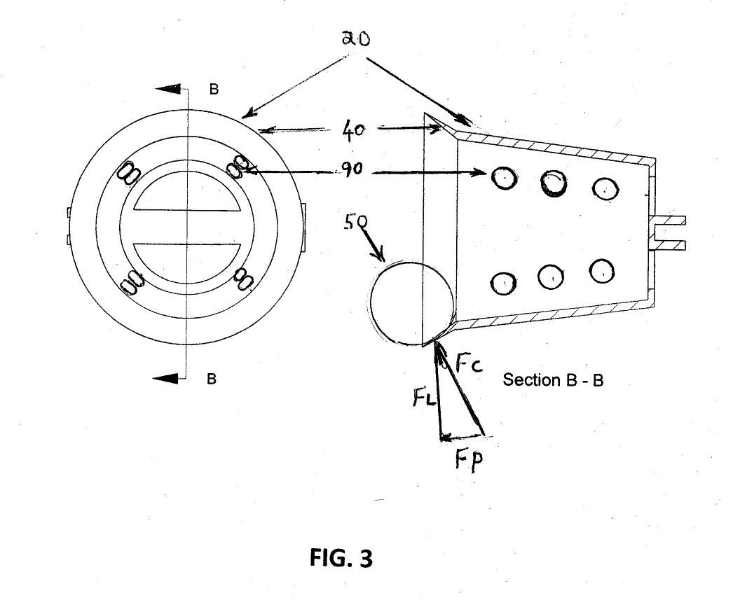

FIG. 3 shows a cross-sectional view of an embodiment with a widening mouth formed by a lip 40 that is slightly angled away from the axis of the cylinder (by an angle of less than 45 degrees). In this embodiment, the contact force FC on the golf ball 50 is also at an angle less than 45 degrees to the vertical. This assures that the lifting force FL is always greater than the pushing force FP. As a result, this assures that the ball will be lifted up in front of the capturing member 20 rather than being pushed away from it. In sone embodiments the lip may be curved to form a spout to aid in pouring out water.

This uplifting effect can also be accomplished by the rounded or tapered edge 60 of the embodiment in FIG. 2, where the top edge of the capturing device 20 needs only to be thin enough to slide under the golf ball and contact it at a point in its lowest quadrant whereby it provides the uplifting force.

An additional benefit of these tapered or flared designs is the fact that they provide an advantage in casting the capturing device in a mould. The internal and external cross-sections at any level are wider than the cross-sections below them. This means that the internal and external moulds can each be made in one piece without seams, and the capturing device can be removed from the moulds without interference. (If you cast an object inside a tapered milk glass, you can remove it through the top without breaking the glass. If you cast it inside a milk bottle, you can not.)

All Figures also show two large drain openings 70 in the bottom of the capturing member, which permit the easy sweeping of the capturing member through the water by a generally horizontal sweeping forward of the handle, once it has been rotated 90 degrees into the horizontal capturing position. These drain openings 70 should be large enough in area to exceed more than half the area of the bottom, while not being so large as to permit the golf ball to fall through. Additional drain slots 80 or holes 90 may be added to the design to increase the flow of water through the retriever and increase its effectiveness in capturing the ball.

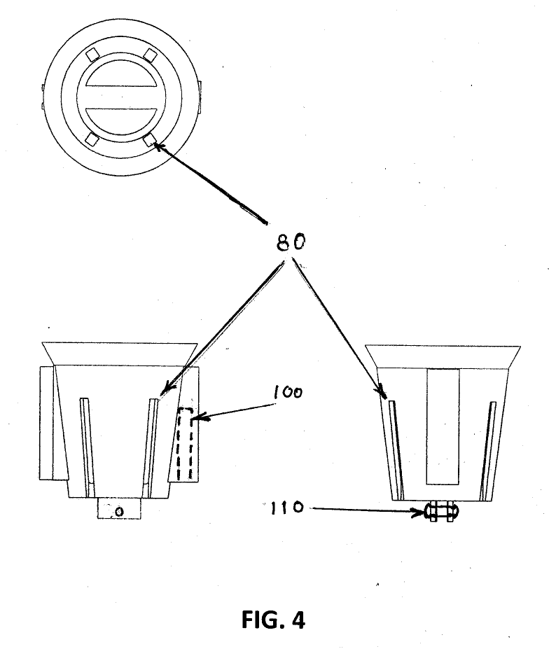

FIG. 4 shows another embodiment where drain slots 80 have been placed in the sides of the capturing device. This can permit a more rapid flow of water through the device, and enhances the forces from the flow that move the golf ball down into the device. While additional drain slots or holes may enhance the operation of the device, they are not essential to the basic functioning of the retriever. However, the design with the slots depicted in FIG. 4 represents the preferred embodiment because of advantages provided by their design in the process of manufacturing.

The drain slots 80 displayed in FIG. 4 contribute further to the ease of manufacturing the capturing member, compared to the drain holes of FIG. 3. This is because they can be cast into the body of the capturing member without creating interference. They can be created by the external mold by an extrusion that passes up through the floor of the capturing member and continues up through the side to the height of the slot. In this way, the internal mold and casting can be lifted out of and away from the external mold.

When the handle is attached to the capturing device above the center of the cylinder, as shown, the force that can be exerted on the edge or lip of the cylinder is greater than it would be if the handle attachment point came at the center or below. This design feature enables the capturing device to exert sufficient force on its edge or lip to get under the resting golf ball. Also, the generally circular design of the capturing device permits it to contact the floor of the hazard in a single spot. This is important because the floor of the hazard is generally not flat, and this design feature permits the capture of golf balls that would be ridden over by the longer, flatter rake-like devices.

FIG. 4 also shows additional details of assembling the invention, including attaching means 110 on the bottom of the capturing member, which requires only a single drilled hole for attachment, which can be drilled at the same time as drilling the handle socket. This permits the firm attachment of the handle to the capturing device. These attaching means on the capturing member also permit the separate manufacture of the handle from the capture member, with easy assembly.

Although these and other details of construction have been described with a degree of particularity, it is the intent that the invention include all modifications and alterations from the disclosed design falling within the spirit or scope of the appended

This detailed description explains how a properly designed capturing device that can be combined with a properly designed and attached handle to provide a simple, effective, and easily manufactured device for the retrieval of golf balls.

The invention claimed is:

1. A golf ball retrieving device comprising a capturing member and a handle, said capturing member comprising:
i) a generally cylindrical shaped or slightly tapered cylindrical body, the walls of said cylinder being sufficiently thin at their top edge to easily pass under a golf ball and
ii) a bottom having drain openings, said drain openings encompassing an area at least half the area of said bottom, with no drain openings being large enough for a golf ball to pass through it and
said handle comprising a straight portion and a bent portion all in one plane said bent portion being shaped so as to wrap around said capturing member in a manner so that the plane of the handle contains the center line of said capturing member and
said straight portion of said handle intersecting said center line at a point above the center of gravity of said capturing member.

2. The golf ball retrieving device of claim 1 where said capturing member has additional drain slots in its sides.

3. A golf ball retrieving device comprising a capturing member and a handle, said capturing member comprising:
i) a generally cylindrical shaped or slightly tapered cylindrical body, the walls of said cylinder being sufficiently thin at their top edge to easily pass under a golf ball and
ii) a flared lip on the top edge of said cylinder, said lip being angled out from said cylindrical body at an angle of less than 45 degrees and
iii) a bottom having drain openings, said drain openings encompassing an area at least half the area of said bottom, with no drain opening being large enough for a golf ball to pass through it and
said handle comprising a straight portion and a bent portion all in one plane said bent portion being shaped so as to wrap around said capturing member in a manner so that the plane of the handle contains the center line of said capturing member and
said straight portion of said handle intersecting said center line at a point above the center of gravity of said capturing member.

4. The golf ball retrieving device of claim 3 where the capturing member has additional drain holes in its sides.

5. A golf ball retrieving device comprising a capturing member and a handle, said capturing member comprising:
i) a generally cylindrical shaped or slightly tapered cylindrical body, the walls of said cylinder being sufficiently thin at their top edge to easily pass under a golf ball and
ii) a bottom having drain openings, said drain openings encompassing an area at least half the area of said bottom, with no drain openings being large enough for a golf ball to pass through it and
iii) drain slots in the walls of said cylinder which aid in the flow of water, said slots having a shape created by a mold component which is an extrusion of a rectangular solid up through said bottom of said capturing member so as to create no interference with the removal of the capturing device from the mold and
said handle comprising a straight portion and a bent portion all in one plane said bent portion being shaped so as to wrap around said capturing member in a manner so that the plane of the handle contains the center line of said capturing member and
said straight portion of said handle intersecting said center line at a point above the center of gravity of said capturing member.

6. The method of manufacturing the golf ball retrieving device of claim 5 which permits the use of two mold components with no seams.
